(19) United States
(12) Patent Application Publication
(10) Pub. No.: US 2016/0334952 A1
(43) Pub. Date: Nov. 17, 2016

(54) TERMINAL AND METHOD FOR SORTING PAGES OF USER INTERFACE

(71) Applicant: HISENSE MOBILE COMMUNICATIONS TECHNOLOGY CO., LTD., Qingdao (CN)

(72) Inventor: Peng JIA, Qingdao (CN)

(21) Appl. No.: 14/956,664

(22) Filed: Dec. 2, 2015

(30) Foreign Application Priority Data
May 15, 2015 (CN) 201510250818.3
Aug. 31, 2015 (CN) 201510543186.X

(51) Int. Cl. G06F 3/0483; G06F 3/0482; G06F 3/0484; G06F 3/0481

(52) U.S. Cl. CPC G06F 3/0483; G06F 3/04817; G06F 3/0482; G06F 3/04842; G06F 3/04845

(57) ABSTRACT

Some embodiments of the disclosure disclose a terminal and method for sorting pages of a user interface. In some embodiments of the disclosure, the terminal displays a plurality of page thumbnails, obtains a clicking operation on at least one of the page thumbnails, and determines an order in which a page corresponding to the at least one page thumbnail is displayed on the user interface, in response to the clicking operation.

### CROSS-REFERENCE TO RELATED APPLICATIONS

This application claims the benefit and priority of Chinese Patent Application No. 201510250818.3 filed May 15, 2015 and Chinese Patent Application No. 201510543186.X filed Aug. 31, 2015. The entire disclosures of each of the above applications are incorporated herein by reference.

### FIELD

The present disclosure relates to the field of interactions and particularly to a method and terminal for sorting pages of a user interface.

### BACKGROUND

This section provides background information related to the present disclosure which is not necessarily prior art.

Along with rapid development of the communication industry, there are more and more functions of smart terminals, and also more and more applications which can be installed on the various smart terminals. Typically the smart terminals are generally provided with a User Interface (UI) for human to machine interaction with their users, where the user interface generally includes pages on which various plug-ins, icons, etc., are presented to the users.

### SUMMARY

This section provides a general summary of the disclosure, and is not a comprehensive disclosure of its full scope or all of its features.

In an aspect, some embodiments of the disclosure provide a method for sorting pages of a user interface, the method including:

displaying, by a terminal, a plurality of page thumbnails;

obtaining, by the terminal, a clicking operation on at least one of the page thumbnails; and

determining, by the terminal, an order in which a page corresponding to the at least one page thumbnail is displayed on the user interface, in response to the clicking operation.

In another aspect, some embodiments of the disclosure further provide a terminal including:

one or more processors; and

a memory, wherein:

the memory stores therein one or more computer readable program codes, and the processor or processors are configured to execute the one or more computer readable program codes to perform:

displaying a plurality of page thumbnails;

obtaining a clicking operation on at least one of the page thumbnails; and

determining an order in which a page corresponding to the at least one page thumbnail is displayed on a user interface, in response to the clicking operation.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a schematic diagram of pages of a user interface;

FIG. 2 illustrates a schematic diagram of entering a page sorting mode when a finger of a user slides on a screen;

FIG. 3 illustrates a schematic diagram of page thumbnails;

FIG. 4 illustrates a schematic flow chart of a method for sorting pages of a user interface according to some embodiments of the disclosure;

FIG. 5 illustrates a schematic diagram of entering a page sorting mode when a user clicks on or slides in a predetermined area of a screen according to some embodiments of the disclosure;

FIG. 6 illustrates a schematic diagram of clicking on a page thumbnail according to some embodiments of the disclosure;

FIG. 7 illustrates a schematic diagram of clicking on a plurality of page thumbnails according to some embodiments of the disclosure;

FIG. 8 illustrates a schematic diagram of sorting pages by putting page thumbnails onto the top according to some embodiments of the disclosure;

FIG. 9 illustrates a schematic diagram of a user interface after pages are sorted according to some embodiments of the disclosure;

FIG. 10 illustrates a schematic flow chart of a method for sorting pages of a user interface of a smart mobile phone according to some embodiments of the disclosure;

FIG. 11 illustrates a schematic structural diagram of a terminal according to some embodiments of the disclosure; and

FIG. 12 illustrates a schematic structural diagram of another terminal according to some embodiments of the disclosure.

### DETAILED DESCRIPTION

Example embodiments will now be described more fully with reference to the accompanying drawings.

Firstly some terms in some embodiments of the disclosure will be described to facilitate understanding by those skilled in the art:

A user interface: an interface on a terminal for interaction with a user.

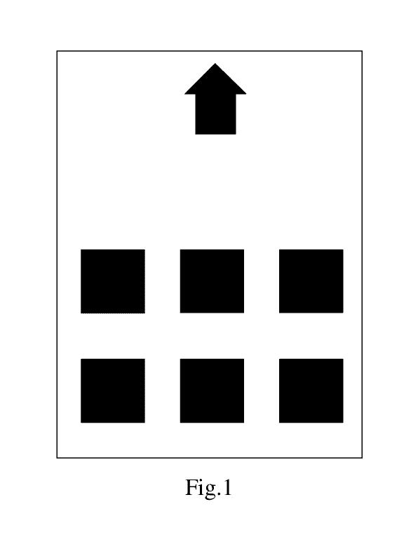

A page of a user interface: a page on which icons of applications and/or icons of plug-ins are displayed, for example, FIG. 1 illustrates six boxes in gray to represent icons of applications and/or icons of plug-ins, where the logo at the top of FIG. 1 is a logo of a homepage.

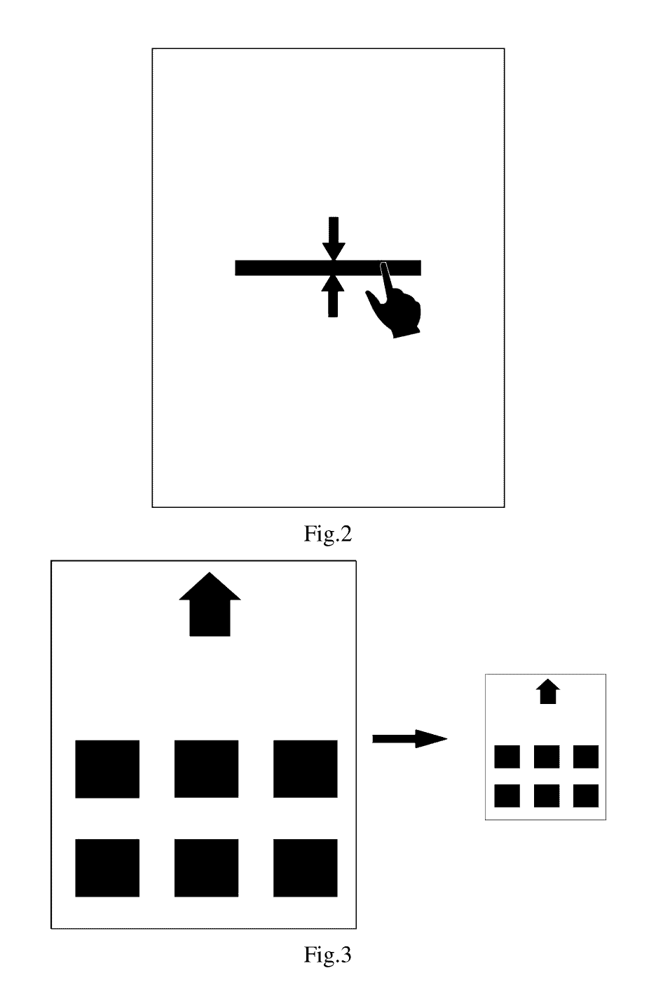

A page sorting mode: a mode which can be entered in a number of ways, for example, FIG. 2 illustrates entering the mode when a finger of a user slides on a screen.

A page thumbnail: a small-size view into which a page is compressed, and which includes the same contents as the contents of the page. As illustrated in FIG. 3, the view on the left represents the page, and the view on the right to which an arrow is directed is the page thumbnail.

Some embodiments of the disclosure can be applicable to various terminals with a display screen, and various smart terminals with a touch screen (e.g., a smart mobile phone, a tablet computer, a notebook computer, a PC, etc.).

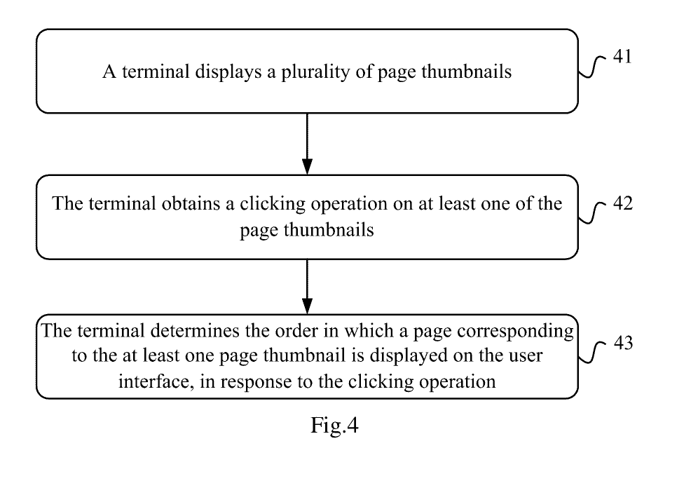

FIG. 4 illustrates a schematic flow chart of a method for sorting pages of a user interface according to some embodiments of the disclosure, where the flow includes:

In the operation 41, a terminal displays a plurality of page thumbnails;

In some embodiments, the terminal can display the plurality of page thumbnails on a user interface in a page sorting mode to receive a clicking operation by a user on at least one of the page thumbnails.

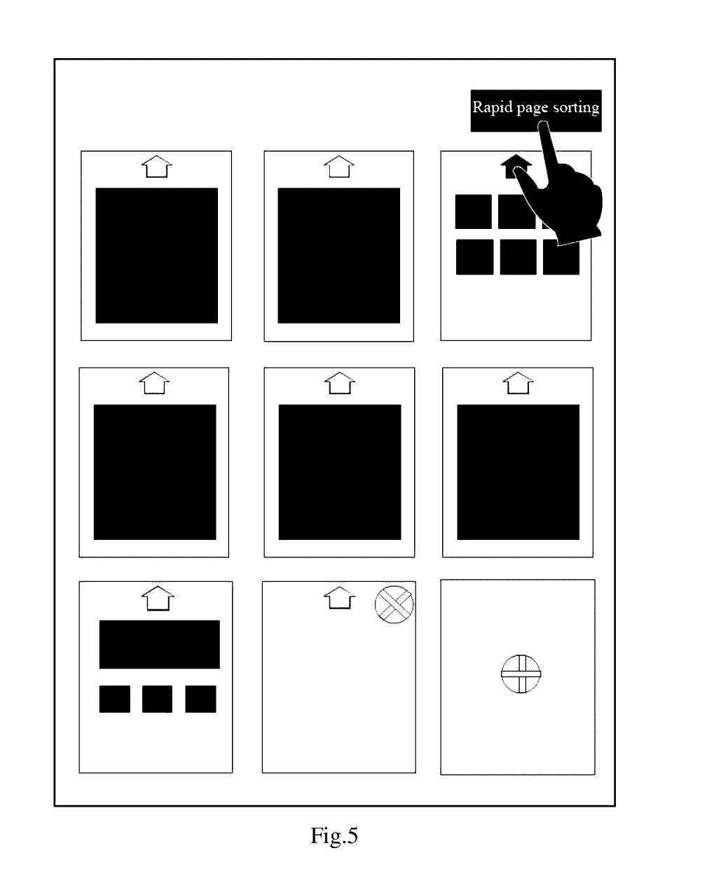

As illustrated in FIG. 2, the user can enter the page sorting mode by sliding on the display screen of the terminal, or as illustrated in FIG. 5, the user clicks on or slides in a predetermined area of the display screen of the terminal (the area of “Rapid sorting of pages” as illustrated in FIG. 5, where “Rapid sorting of pages” here can be a physical button or can be a virtual button), so that the terminal displays the plurality of page thumbnails upon reception of the clicking or sliding operation to receive a clicking operation by the user on at least one of the thumbnails of the pages. In FIG. 5, the symbol “X” at the upper right corner in the page thumbnail at the middle of the third row from the top to the bottom indicates that if the symbol is clicked on, then the page thumbnail will be removed, and the third picture from the left to the right in the third row is not a page thumbnail, which indicates that a new page thumbnail can be added.

In the operation 42, the terminal obtains a clicking operation on at least one of the page thumbnails;

In some embodiments, the terminal displays the page thumbnails of all the pages of the user interface, and the user can click on all the page thumbnails or can click on a part or even one of the page thumbnails.

In the operation 43, the terminal determines the order in which a page corresponding to the at least one page thumbnail is displayed on the user interface, in response to the clicking operation.

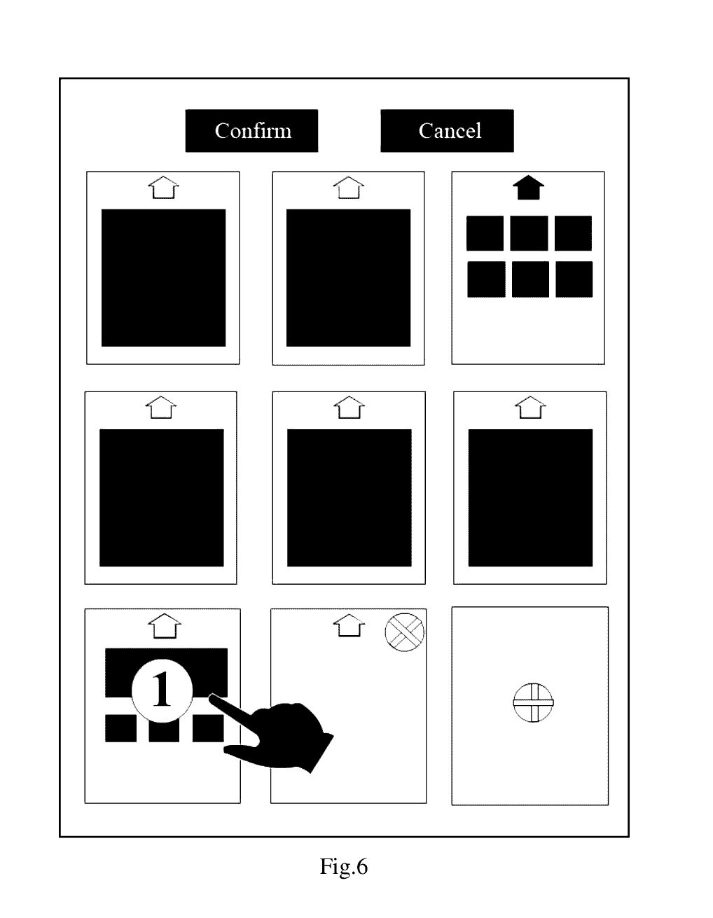

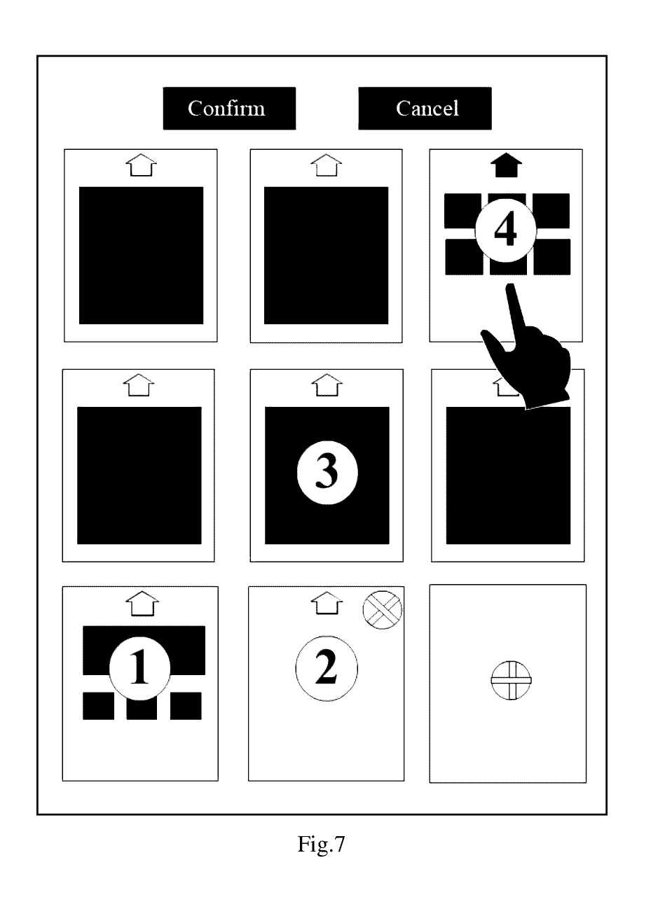

In some embodiments, the terminal determines the order in which the page corresponding to the page thumbnail is displayed on the user interface, according to an instance of time when the user clicks on the page thumbnail. As illustrated in FIG. 6, if the user firstly clicks on the page thumbnail on the left of the third row from the top to the bottom in the figure, that is, the page thumbnail is clicked on at the earliest instance of time, then the terminal determines that the page corresponding to the page thumbnail is firstly displayed on the user interface, and in some embodiments, a corresponding order number is displayed on the clicked-on page thumbnail according to the instance of time of being clicked on. As illustrated in FIG. 6, if the user firstly clicks on the page thumbnail on the left of the third row from the top to the bottom in the figure, then the order number 1 is displayed on the page thumbnail. As illustrated in FIG. 7, if the user clicks on the page thumbnails on the left of the third row, at the middle of the third row, at the middle of the second row, and on the right of the first row sequentially, then the order numbers 1, 2, 3, and 4 are displayed sequentially on the respective page thumbnails, and the terminal determines the order in which the pages corresponding to the page thumbnails are displayed on the user interface, according to the order numbers.

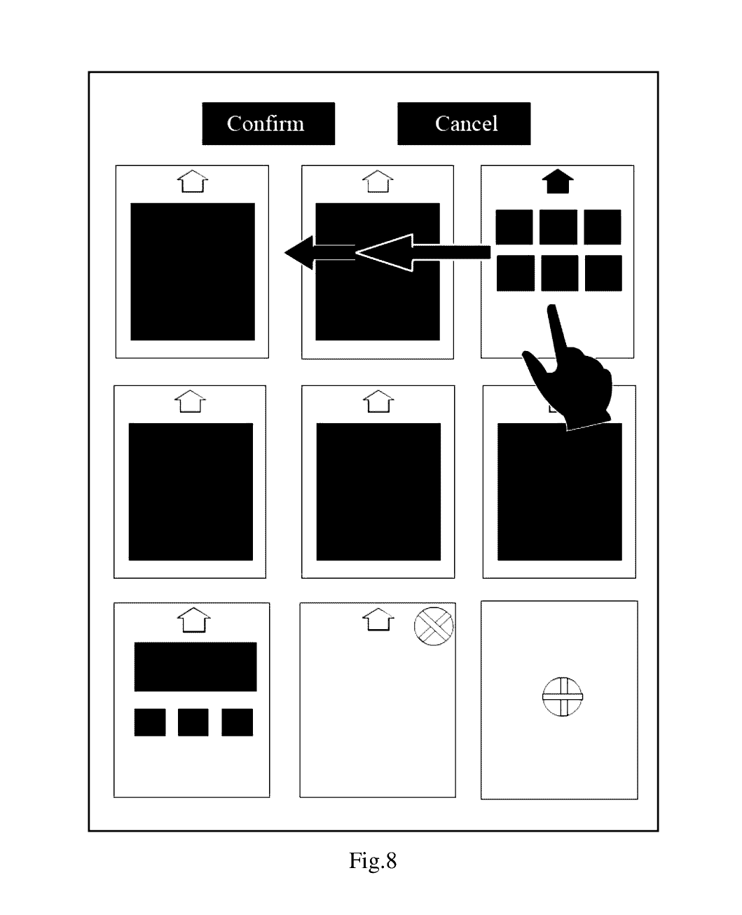

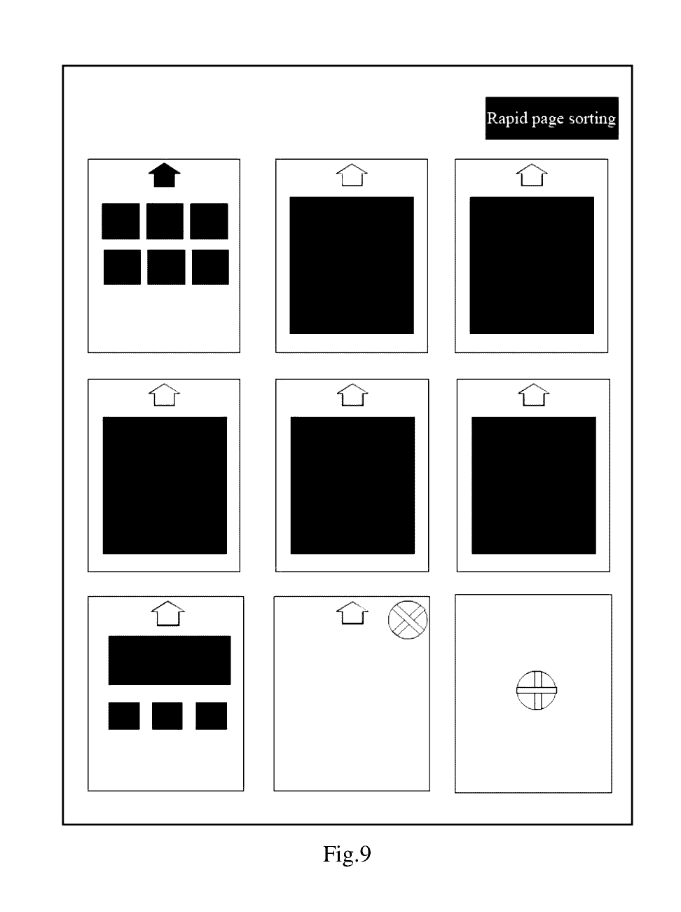

In some embodiments, if the user clicks on some page thumbnail, then the terminal puts the clicked-on page thumbnail onto the top, that is, sets the order in which a page corresponding to the clicked-on page thumbnail is displayed, so that the page is firstly displayed. As illustrated in FIG. 8, if the user clicks on the page thumbnail on the rightmost of the first row from the top to the bottom in FIG. 8, then the page thumbnail receiving the clicking operation is put onto the top in the direction denoted by the arrow in the figure, so that the pages are sorted as illustrated in FIG. 9. If the user clicks on a next page thumbnail, then the next page thumbnail is further set onto the top, and so on.

In some embodiments, if the terminal displays a plurality of page thumbnails, then at least one edge of at least one of the displayed page thumbnails is highlighted (not illustrated).

In some embodiments, if all the page thumbnails are clicked on, then a preset mapping relationship between the pages and the order in which they are displayed is obtained; for the page thumbnails, all of which are clicked on, the obtained mapping relationship is updated according to sequential instances of time when they are clicked on; and the order in which the pages corresponding to the respective page thumbnails are displayed on the user interface is determined according to the updated mapping relationship.

In some embodiments, if a part of the page thumbnails are clicked on, then a preset mapping relationship between the pages and the order in which they are displayed is obtained; for the part of the page thumbnails, the mapping relationship between the pages corresponding to the clicked-on part of the page thumbnails and the order in which they are displayed is updated according to sequential instances of time when they are clicked on; and for other page thumbnails except for the clicked-on part of the page thumbnails, the mapping relationship between the pages corresponding to the other page thumbnails and the order in which they are displayed is updated according to the positions of the other page thumbnails relative to each other, and the updated mapping relationship between the pages corresponding to the part of the page thumbnails and the order in which they are displayed, so that the mapping relationship between all the pages and the order in which they are displayed can be updated to thereby determine the order in which all the pages are displayed on the user interface.

In some embodiments, after the order in which the page corresponding to the at least one page thumbnail is displayed on the user interface is determined, if there is a page thumbnail clicked on again, then the page thumbnail clicked on again is treated as a page thumbnail which is not clicked on. Alternatively a record, of the page corresponding to the page thumbnail, in the updated mapping relationship can be removed, or the order in which the respective pages are displayed on the user interface before the terminal enters the page sorting mode can be resumed.

In some embodiments, if the terminal in the page sorting mode obtains an instruction to exit the page sorting mode, then the order in which the respective pages are displayed on the user interface before the terminal enters the page sorting mode can be resumed.

The following description will be given taking a user interface of a smart mobile phone as an example. It shall be noted that some embodiments of the disclosure can be applicable to a terminal with an Android system and also to a terminal with another operating system, including but not limited to a smart mobile phone.

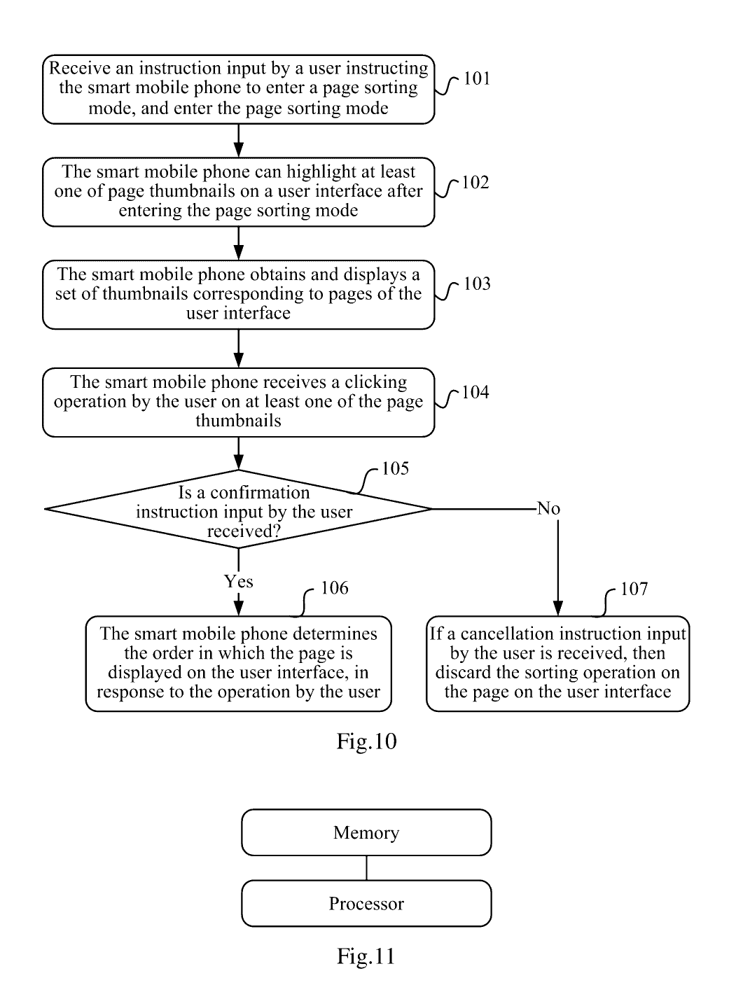

FIG. 10 illustrates a schematic flow chart of a method for sorting pages in a smart mobile phone according to some embodiments of the disclosure, where the page sorting flow can include the following operations:

The operation 101 is to receive an instruction input by a user instructing the smart mobile phone to enter a page sorting mode, and to enter the page sorting mode.

The user can instruct the smart mobile phone to enter the page sorting mode (which can also be referred to as a rapid page sorting mode) by inputting a preset instruction. The preset instruction can include but will not be limited to clicking on a predetermined area on a touch screen, clicking on a physical button having the function of entering the rapid page sorting mode and arranged on the smart mobile phone, clicking on a combination of buttons arranged on the smart mobile phone, etc.

By way of an example, as illustrated in FIG. 5, the user enters the page sorting mode by clicking on a button “Rapid page sorting” on a user interface of the smart mobile phone.

In the operation 102, the smart mobile phone can highlight at least one of page thumbnails on a user interface after entering the page sorting mode.

The smart mobile phone can highlight at least one edge of the at least one page thumbnail on the user interface to alert the user that the smart mobile phone operates in the page sorting mode; and of course, the smart mobile phone can alert otherwise the user that the smart mobile phone operates in the page sorting mode.

It shall be noted that the operation 102 above can provide the user with an optional visual effect to alert the user about the mode in which the smart mobile phone operates; and in a real application, the smart mobile phone can perform the operation 103 directly after the operation 101 without performing the operation 102.

In the operation 103, the smart mobile phone obtains and displays a set of thumbnails corresponding to pages of the user interface.

The smart mobile phone can obtain a mapping relationship, preset in the terminal, between the pages of the user interface and the corresponding order in which they are displayed, where the mapping relationship can be a set of thumbnails (which includes thumbnails and positional information of the thumbnails in the user interface). The mapping relationship can include identifiers of the pages, and a correspondence relationship between the thumbnails and the order in which they are displayed. By way of an example, the smart mobile phone can use a thumbnail A to represent a page A, where the page A is the identifier of the page, and if the page A is firstly displayed, then a correspondence relationship between the page A, the thumbnail A, and the order in which it is displayed can be created. That is, the set of thumbnails can indicate the correspondence relationship between the identifiers of the respective pages, the thumbnails, and the order in which they are displayed, and the set of thumbnails can further include the positions where the page thumbnails in the user interface are located on the touch screen (or coordinates, areas, etc.) when the terminal operates in the page sorting mode, so that the smart mobile phone can determine the clicked-on thumbnail at the position where the user clicks on the touch screen, to thereby sort the pages according to the correspondence relationship between the identifiers of the respective pages, the thumbnails, and the order in which they are displayed.

In the operation 104, the smart mobile phone receives a clicking operation by the user on at least one of the page thumbnails.

The terminal can number the page (the number is the order in which the page corresponding to the page thumbnail is sorted on the user interface) according to an instance of time when the user clicks on the page thumbnail. As illustrated in FIG. 6, if the user firstly clicks on the thumbnail at the bottom left corner, and the display order number of the page corresponding to the thumbnail is 1, then it can be determined that the page corresponding to the thumbnail is firstly presented on the user interface; and as illustrated in FIG. 7, the user can click on the other page thumbnails sequentially to determine the order in which the corresponding pages are displayed, and after the user clicks on the second thumbnail in the third row, the second thumbnail in the second row, and the third thumbnail in the first row sequentially, the display order numbers of the corresponding pages are 2, 3, and 4 sequentially, so it can be determined that the user determines the order in which the pages corresponding to the page thumbnails are displayed, so that the pages are secondly, thirdly and fourthly displayed sequentially.

It shall be noted that in some embodiments of the disclosure, the smart mobile phone can temporarily buffer the display order, the page thumbnails, the identifiers of the pages, and other data, and once the user clicks on a cancellation button (which can be a virtual button or a physical button), the smart mobile phone can discard the temporarily buffered data, and if the user clicks on a confirmation button (which can be a virtual button or a physical button), the smart mobile phone can store the temporarily buffered data as the mapping relationship between the pages and the order in which they are displayed.

In the operation 105, the smart mobile phone determines whether a confirmation instruction input by the user is received, and if so, then the flow proceeds to the operation 106; otherwise, the flow proceeds to the operation 107.

As illustrated in FIG. 7 again, it is determined whether the user clicks on the “Confirm” button, where the “Confirm” button here can be a physical button or can be a predetermined area, that is, it is determined whether the user has input the confirmation instruction, and if the terminal receives an operation by the user on the “Confirm” button or the predetermined area after receiving the clicking operation by the user on the page thumbnail in FIG. 7, then the flow proceeds to the operation 106: the smart mobile phone determines the order in which the page is displayed on the user interface, in response to the operation by the user; and if the terminal receives an operation by the user on the “Cancel” button or a predetermined area after receiving the clicking operation by the user on the page thumbnail in FIG. 7, then the flow proceeds to the operation 107: the smart mobile phone discards the sorting operation on the page on the user interface.

Some embodiments of the disclosure can provide a buffering mechanism for sorting, where the original order in which the pages are displayed can be resumed once the cancellation operation by the user is received to thereby provide the user with a better operation experience.

In the embodiments of the disclosure, the smart mobile phone can be provided with at least one page, and if the smart mobile phone is provided with only one page, the page will be firstly displayed after the user clicks the page; and if the smart mobile phone is provided with more than one page, the method according to some embodiments of the disclosure can obtain the instance of time when the page thumbnail is clicked on, and sort the page corresponding to the at least one clicked-on page thumbnail according to the instance of time when the page thumbnail is clicked on, or sort the page corresponding to the clicked-on page thumbnail dependent upon how the page thumbnail is put onto the top. Since the order in which the page of the user interface is displayed can be reevaluated simply as a result of the clicking operation by the user, the operation by the user can be simplified, and the experience of the user can be improved.

It shall be noted that if the smart mobile phone enters the “page sorting mode”, or the terminal receives the operation instruction on the predetermined area, then the smart mobile phone can display sorting guidance alert information (not illustrated) to describe briefly how to operate the page sorting function so as to guide the user; and no guidance alert will be further given when the function is accessed subsequently.

As illustrated in FIG. 11, some embodiments of the disclosure further provide a terminal which can perform the method for sorting pages of a user interface according to some embodiments above, or the method for sorting pages of a user interface according to some embodiments above can be performed by the terminal. The terminal can include:

One or more processors; and

A memory, where:

The memory stores therein one or more computer readable program codes, and the processor or processors are configured to execute the one or more computer readable program codes to perform:

Displaying a plurality of page thumbnails;

Obtaining a clicking operation on at least one of the page thumbnails; and

Determining the order in which a page corresponding to the at least one page thumbnail is displayed on a user interface, in response to the clicking operation. In some embodiments, when the order in which the page corresponding to the at least one page thumbnail is displayed on the user interface is determined, the one or more processors are further configured to execute the one or more computer readable program codes to perform: determining the order in which the page corresponding to the at least one page thumbnail is displayed on the user interface, according to an instance of time of the clicking operation, and the page thumbnail clicked on at the instance of time.

In some embodiments, when the order in which the page corresponding to the at least one page thumbnail is displayed on the user interface is determined, the one or more processors are further configured to execute the one or more computer readable program codes to perform: setting the clicked-on page thumbnail onto the top according to the clicking operation, and determining the order in which the page corresponding to the at least one page thumbnail is displayed on the user interface.

In some embodiments, when the plurality of page thumbnails are displayed, the one or more processors are further configured to execute the one or more computer readable program codes to perform: highlighting at least one edge of the at least one page thumbnail.

In some embodiments, before the plurality of page thumbnails are displayed, the one or more processors are further configured to execute the one or more computer readable program codes to perform: receiving an operation instruction on a predetermined area; and displaying the plurality of page thumbnails in response to the operation instruction.

In some embodiments, when the order in which the page corresponding to the at least one page thumbnail is displayed on the user interface is determined, the one or more processors are further configured to execute the one or more computer readable program codes to perform:

Displaying an order number corresponding to the instance of time when the clicked-on page thumbnail is clicked on, on the clicked-on page thumbnail according to the page thumbnail, and the instance of time; and determining the order in which the page corresponding to the at least one page thumbnail is displayed on the user interface, according to the order number.

In some embodiments, if all the page thumbnails are clicked on, when the order in which the page corresponding to the at least one page thumbnail is displayed on the user interface is determined according to the instance of time of the clicking operation, and the page thumbnail clicked on at the instance of time, the one or more processors are further configured to execute the one or more computer readable program codes to perform:

Obtaining a preset mapping relationship between the pages and the order in which they are displayed;

Updating the obtained mapping relationship according to the sequential order of instances of time when the respective page thumbnails are clicked on; and

Determining the order in which the pages corresponding to the respective page thumbnails are displayed on the user interface, according to the updated mapping relationship.

In some embodiments, if a part of the page thumbnails are clicked on, when the order in which the page corresponding to the at least one page thumbnail is displayed on the user interface is determined according to the instance of time of the clicking operation, and the page thumbnail clicked on at the instance of time, the one or more processors are further configured to execute the one or more computer readable program codes to perform:

Obtaining a preset mapping relationship between the pages and the order in which they are displayed;

Updating the mapping relationship between the pages corresponding to the part of the page thumbnails and the order in which they are displayed, according to the sequential order of instances of time when the part of the page thumbnails are clicked on;

For other page thumbnails except for the part of the page thumbnails, updating the mapping relationship between the pages corresponding to the other page thumbnails and the order in which they are displayed, according to the positions of the other page thumbnails relative to each other, and the updated mapping relationship between the pages corresponding to the part of the page thumbnails and the order in which they are displayed; and

Determining the order in which the respective pages are displayed on the user interface, according to the updated mapping relationship between the respective pages and the order in which they are displayed.

In some embodiments, after the order in which the page corresponding to the at least one page thumbnail is displayed on the user interface is determined, if there is a page thumbnail clicked on again, the one or more processors are further configured to execute the one or more computer readable program codes to perform:

Treating the page thumbnail clicked on again as a page thumbnail which is not clicked on.

In some embodiments, after the terminal receives the operation instruction on the predetermined area, the one or more processors are further configured to execute the one or more computer readable program codes to perform:

Displaying sorting guidance alert information on the user interface.

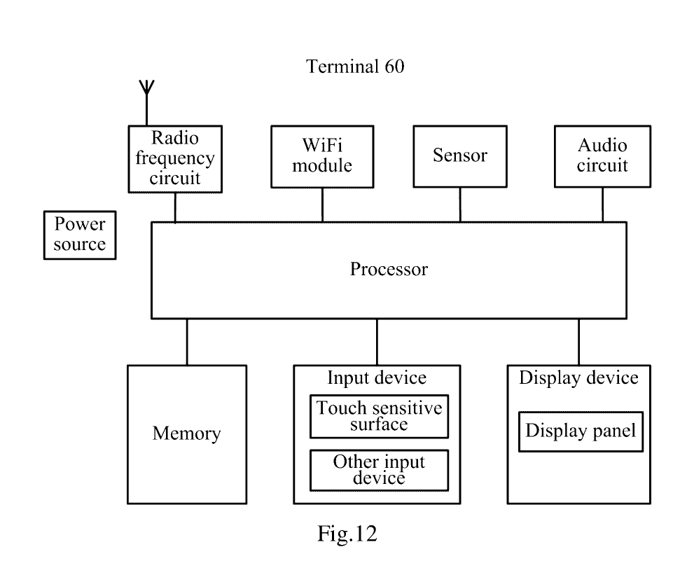

By way of an example, the terminal according to some embodiments of the disclosure can be structured as illustrated in FIG. 12, where the terminal 60 can include a memory, an input unit, an output unit, one or more processors, and other components. Those skilled in the art can appreciate that the structure of the terminal illustrated in FIG. 12 will not be limiting on the terminal but can include more or less components than those as illustrated or some of the components can be combined or different components can be configured.

The memory can be configured to store software programs and modules, and the processor is configured to run the software programs and modules stored in the memory to thereby perform various functional applications and data processes. The memory can include a high-speed random access memory and can further include a nonvolatile memory, e.g., at least one magnetic-disk memory device, a flash memory device or another volatile solid memory device. Furthermore the memory can further include a memory controller configured to provide an access of the processor and the input unit to the memory.

The processor is a control center of the terminal 60 and has the respective components of the entire smart terminal connected by various interfaces and lines. The processor can run or execute the software programs and/or modules stored in the memory and invoke the data stored in the memory to perform the various functions of the terminal and process the data to thereby manage and control the terminal as a whole. Alternatively, the processor can include one or more processing cores. Alternatively, the processor can be integrated with an application processor and a modem processor, where the application processor generally handles an operating system, user interfaces, applications, etc., and the modem processor generally handles wireless communication. As can be appreciated, the modem processor may not be integrated into the processor.

The terminal 60 can include a TV and radio receiver, a High-Definition Multimedia (HDMI) interface, a USB interface, an audio and video input interface, and other input units. The input units can further include a remote controller receiver to receive a signal sent by a remote controller. Moreover the input units can further include a touch sensitive surface and other input devices, where the touch sensitive surface can be embodied in various types of resistive, capacitive, infrared, surface sound wave and other types, and the other input devices can include but will not be limited to one or more of a physical keyboard, functional keys (e.g., a power-on or-off press key, etc.), a track ball, a mouse, a joystick, etc.

The output unit is configured to output an audio signal, a video signal, an alert signal, a vibration signal, etc. The output unit can include a display panel, a sound output module, etc. The display panel can be configured to display information input by a user or information provided to the user and various graphic user interfaces of the terminal, where these graphic user interfaces can be composed of graphics, texts, icons, videos and any combination thereof. For example, the display panel can be embodied as a Liquid Crystal Display (LCD), an Organic Light-Emitting Diode (OLED), a flexible display, a 3D display, a CRT, a plasmas display panel, etc.

The terminal 60 can further include at least one sensor (not illustrated), e.g., an optical sensor, a motion sensor and other sensors. Particularly the optical sensor can include an ambient optical sensor and a proximity sensor, where the ambient optical sensor can adjust the brightness of the display panel according to the luminosity of ambient light rays, and the proximity sensor can power off the display panel and/or a backlight when the terminal 60 moves to some position. The terminal 60 can be further configured with a gyroscope, a barometer, a hygrometer, a thermometer, an infrared sensor and other sensors.

The terminal 60 can further include an audio circuit (not illustrated), and a speaker and a transducer can provide an audio interface between the user and the terminal 60. The audio circuit can convert received audio data into an electric signal and transmit the electric signal to the speaker, which is converted by the speaker into an audio signal for output; and on the other hand, the transducer converts a collected audio signal into an electric signal which is received by the audio circuit and then converted into audio data, and the audio data is further output to the processor for processing and then transmitted to another terminal, for example, or the audio data is output to the memory for further processing. The audio circuit may further include an earphone jack for communication between a peripheral earphone and the terminal 60.

Moreover the terminal 60 can further include a Radio Frequency (RF) circuit. The RF circuit can be configured to receive and transmit a signal. Typically the RF circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the terminal 60 can further include a web cam, a Bluetooth module, etc.

Moreover the terminal 60 can further include a Wireless Fidelity (WiFi) module (not illustrated). The WiFi falls into the category of short-range wireless transmission technologies, and the terminal can assist the user in receiving and transmitting an e-mail, browsing a webpage, accessing streaming media, etc., through the WiFi module by which the user is provided with a wireless access to the broadband Internet. Although the WiFi module is illustrated in FIG. 12, it can be appreciated that it may not be necessarily required for the terminal 60 but can be omitted as desired without departing from the scope of the disclosure.

In another aspect, some embodiments of the disclosure further provide a computer readable storage medium which can be a computer readable storage medium included in the memory in the embodiments above; or can be a separately existing computer readable storage medium which is not installed into the terminal. The computer readable storage medium stores therein one or more programs (in some embodiments, the computer readable storage medium can be one or more magnetic-disk storage devices, flash memory devices or other nonvolatile solid storage devices, CD-ROMs, optical memories, etc.), and the one or more programs can be executed by one or more processors to perform a method for sorting pages of a user interface.

The disclosure has been described in a flow chart and/or a block diagram of the method, the device (system) and the computer program product according to the embodiments of the disclosure. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational operations are performed on the computer or the other programmable data processing device to create a computer implemented process so that the instructions executed on the computer or the other programmable device provide operations for performing the functions specified in the flow(s) of the flow chart and/or the block(s) of the block diagram.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A terminal, comprising:
one or more processors; and
a memory, wherein:
the memory stores therein one or more computer readable program codes, and the processor or processors are configured to execute the one or more computer readable program codes to perform:
displaying a plurality of page thumbnails;
obtaining a clicking operation on at least one of the page thumbnails; and
determining an order in which a page corresponding to the at least one page thumbnail is displayed on a user interface, in response to the clicking operation.

2. The terminal according to claim 1, wherein when the order in which the page corresponding to the at least one page thumbnail is displayed on the user interface is determined, the one or more processors are further configured to execute the one or more computer readable program codes to perform:
determining the order in which the page corresponding to the at least one page thumbnail is displayed on the user interface, according to an instance of time of the clicking operation, and the page thumbnail clicked on at the instance of time.

3. The terminal according to claim 1, wherein when the order in which the page corresponding to the at least one page thumbnail is displayed on the user interface is determined, the one or more processors are further configured to execute the one or more computer readable program codes to perform:
setting the clicked-on page thumbnail onto the top according to the clicking operation, and determining the order in which the page corresponding to the at least one page thumbnail is displayed on the user interface.

4. The terminal according to claim 1, wherein when the plurality of page thumbnails are displayed, the one or more processors are further configured to execute the one or more computer readable program codes to perform:
highlighting at least one edge of the at least one page thumbnail.

5. The terminal according to claim 1, wherein before the plurality of page thumbnails are displayed, the one or more processors are further configured to execute the one or more computer readable program codes to perform:
receiving an operation instruction on a predetermined area; and
displaying the plurality of page thumbnails in response to the operation instruction.

6. The terminal according to claim 2, wherein when the order in which the page corresponding to the at least one page thumbnail is displayed on the user interface is determined, the one or more processors are further configured to execute the one or more computer readable program codes to perform:
displaying an order number corresponding to the instance of time when the clicked-on page thumbnail is clicked on, on the clicked-on page thumbnail according to the page thumbnail, and the instance of time; and
determining the order in which the page corresponding to the at least one page thumbnail is displayed on the user interface, according to the order number.

7. The terminal according to claim 2, wherein if all the page thumbnails are clicked on, when the order in which the page corresponding to the at least one page thumbnail is displayed on the user interface is determined according to the instance of time of the clicking operation, and the page thumbnail clicked on at the instance of time, the one or more processors are further configured to execute the one or more computer readable program codes to perform:
obtaining a preset mapping relationship between the pages and the order in which they are displayed;
updating the obtained mapping relationship according to a sequential order of instances of time when the respective page thumbnails are clicked on; and
determining the order in which the pages corresponding to the respective page thumbnails are displayed on the user interface, according to the updated mapping relationship.

8. The terminal according to claim 2, wherein if a part of the page thumbnails are clicked on, when the order in which the page corresponding to the at least one page thumbnail is displayed on the user interface is determined according to the instance of time of the clicking operation, and the page thumbnail clicked on at the instance of time, the one or more processors are further configured to execute the one or more computer readable program codes to perform:
obtaining a preset mapping relationship between the pages and the order in which they are displayed;
updating the mapping relationship between the pages corresponding to the part of the page thumbnails and the order in which they are displayed, according to a sequential order of instances of time when the part of the page thumbnails are clicked on;
for other page thumbnails except for the part of the page thumbnails, updating the mapping relationship between the pages corresponding to the other page thumbnails and the order in which they are displayed, according to the positions of the other page thumbnails relative to each other, and the updated mapping relationship between the pages corresponding to the part of the page thumbnails and the order in which they are displayed; and
determining the order in which the respective pages are displayed on the user interface, according to the updated mapping relationship between the respective pages and the order in which they are displayed.

9. The terminal according to claim 1, wherein after the order in which the page corresponding to the at least one page thumbnail is displayed on the user interface is determined, if there is a page thumbnail clicked on again, the one or more processors are further configured to execute the one or more computer readable program codes to perform:
treating the page thumbnail clicked on again as a page thumbnail which is not clicked on.

10. The terminal according to claim 5, wherein after the terminal receives the operation instruction on the predetermined area, the one or more processors are further configured to execute the one or more computer readable program codes to perform:
displaying sorting guidance alert information on the user interface.

11. A method for sorting pages of a user interface, the method comprising:
displaying, by a terminal, a plurality of page thumbnails;
obtaining, by the terminal, a clicking operation on at least one of the page thumbnails; and
determining, by the terminal, an order in which a page corresponding to the at least one page thumbnail is displayed on the user interface, in response to the clicking operation.

12. The method according to claim 11, wherein determining, by the terminal, the order in which the page corresponding to the at least one page thumbnail is displayed on the user interface, in response to the clicking operation comprises:
determining, by the terminal, the order in which the page corresponding to the at least one page thumbnail is displayed on the user interface, according to an instance of time of the clicking operation, and the page thumbnail clicked on at the instance of time.

13. The method according to claim 11, wherein determining, by the terminal, the order in which the page corresponding to the at least one page thumbnail is displayed on the user interface, in response to the clicking operation comprises:
setting, by the terminal, the clicked-on page thumbnail onto the top according to the clicking operation, and determining the order in which the page corresponding to the at least one page thumbnail is displayed on the user interface.

14. The method according to claim 11, wherein displaying, by the terminal, the plurality of page thumbnails comprises:
highlighting at least one edge of the at least one page thumbnail.

15. The method according to claim 11, wherein before the terminal displays the plurality of page thumbnails, the method further comprises:
receiving, by the terminal, an operation instruction on a predetermined area; and
displaying, by the terminal, the plurality of page thumbnails in response to the operation instruction.

16. The method according to claim 12, wherein determining the order in which the page corresponding to the at least one page thumbnail is displayed on the user interface comprises:
displaying, by the terminal, an order number corresponding to the instance of time when the clicked-on page thumbnail is clicked on, on the clicked-on page thumbnail according to the page thumbnail, and the instance of time; and
determining, by the terminal, the order in which the page corresponding to the at least one page thumbnail is displayed on the user interface, according to the order number.

17. The method according to claim 12, wherein if all the page thumbnails are clicked on, determining the order in which the page corresponding to the at least one page thumbnail is displayed on the user interface, according to the instance of time of the clicking operation, and the page thumbnail clicked on at the instance of time comprises:
obtaining a preset mapping relationship between the pages and the order in which they are displayed;
updating the obtained mapping relationship according to a sequential order of instances of time when the respective page thumbnails are clicked on; and
determining the order in which the pages corresponding to the respective page thumbnails are displayed on the user interface, according to the updated mapping relationship.

18. The method according to claim 12, wherein if a part of the page thumbnails are clicked on, determining the order in which the page corresponding to the at least one page thumbnail is displayed on the user interface, according to the instance of time of the clicking operation, and the page thumbnail clicked on at the instance of time comprises:
obtaining a preset mapping relationship between the pages and the order in which they are displayed;
updating the mapping relationship between the pages corresponding to the part of the page thumbnails and the order in which they are displayed, according to a sequential order of instances of time when the part of the page thumbnails are clicked on;
for other page thumbnails except for the part of the page thumbnails, updating the mapping relationship between the pages corresponding to the other page thumbnails and the order in which they are displayed, according to the positions of the other page thumbnails relative to each other, and the updated mapping relationship between the pages corresponding to the part of the page thumbnails and the order in which they are displayed; and
determining the order in which the respective pages are displayed on the user interface, according to the updated mapping relationship between the respective pages and the order in which they are displayed.

19. The method according to claim 11, wherein after the order in which the page corresponding to the at least one page thumbnail is displayed on the user interface is determined, if there is a page thumbnail clicked on again, then the method further comprises:
treating the page thumbnail clicked on again as a page thumbnail which is not clicked on.

20. The method according to claim 15, wherein after the terminal receives the operation instruction on the predetermined area, the method further comprises:
displaying sorting guidance alert information on the user interface.
